(19) United States
(12) Patent Application Publication
(10) Pub. No.: US 2017/0075947 A1
(43) Pub. Date: Mar. 16, 2017

(54) Weightless Data Objects Content Verification

(71) Applicant: EMC Corporation, Hopkinton, MA (US)

(72) Inventors: Andrey Kurilov, Saint Petersburg (RU); Mikhail Danilov, Saint Petersburg (RU); Kirill Gusakov, Saint Petersburg (RU); Olga Zhavzharova, Saint Petersburg (RU); Ivan Tchoub, Saint Petersburg (RU)

(21) Appl. No.: 14/929,788

(22) Filed: Nov. 2, 2015

(30) Foreign Application Priority Data
Sep. 14, 2015 (RU) 2015139056

(51) Int. Cl. G06F 17/30

(52) U.S. Cl. CPC G06F 17/30371; G06F 17/30303

(57) ABSTRACT

A data object content verification technique provides perfect reliability and low storage overhead. Object data is generated in a reproducible manner based upon object locally stored object metadata. The object data is stored to an object storage system. The stored object data is subsequently verified by retrieving the object metadata, regenerating the original object data, and comparing the stored and original object data.

### CROSS REFERENCE TO RELATED APPLICATIONS

This application claims priority to Russian Patent Application number 2015139056, filed Sep. 14, 2015, and entitled “WEIGHTLESS DATA OBJECTS CONTENT VERIFICATION,” which is incorporated herein by reference in its entirety.

### BACKGROUND

Data storage vendors offer a wide range of data storage systems. When new features or other changes are made to a data storage system, thorough testing is performed to maintain outstanding storage quality. For example, at each release development cycle, endurance testing may be performed. One goal of endurance testing is to verify that the content of stored objects is not corrupted with a lapse of time. To facilitate endurance testing, a testing tool may generate many large data objects (further referred to herein as “objects”), store these objects within the storage system, and subsequently read the objects back from storage and verify their contents. In between creating and verifying a given object, a large number of I/O operations may be performed over some relatively long time period, including creating and deleting other objects.

To verify stored object content, a common approach is to calculate a checksum over the object's data and to store the checksum locally, such as to a local disk or other type of non-volatile memory, along with an object ID. When the object is read back, a second checksum is calculated over the stored object data and compared with the locally stored checksum. If the checksums are equal, the object content is verified. Otherwise, the object is reported as corrupted. Because checksums are not one-to-one functions (i.e., the same checksum can be computed for different data), object content verification using checksums is not 100% reliable. In addition, checksums cannot be used to determine the specific data within the object that was corrupted, complicating root cause analysis.

Another approach is to store a replica of each object locally. Although this approach is reliable, it is typically impractical due to the high storage overhead.

### SUMMARY

It is appreciated herein that there is a need for object content verification techniques and structures that are reliable and have reasonable storage overhead.

According to one aspect of the invention, a method comprises determining an object ID, determining an object size, generating original object data using the object ID and the object size, storing the original object data within an object storage system using the object ID, writing the object ID and object size to the metadata storage, reading the object ID and object size from the metadata storage, retrieving the stored object data from the object storage system using the object ID, regenerating the original object data using the object ID and the object size, and comparing the regenerated original object data to the stored object data to identify corruption in the object storage system. In some embodiments, determining the object ID comprises generating an object ID. In certain embodiments, the object storage system comprises a cluster of storage nodes.

In various embodiments, the method further comprises receiving the stored object data as a first data stream, receiving the regenerated original object data as a second data stream, and comparing the first and second data streams to identify corruption in the object storage system. The method may include receiving the first and second data streams in parallel.

In some embodiments, the method further comprises storing pre-generated data in a ring buffer, wherein generating original object data comprising reading data from the ring buffer.

According to another aspect of the invention, a system comprises a content generator configured to generate a stream of data having a specified size, the stream of data reproducible based upon a specified key; an object creator; an object reader; and a content verifier. The object creator may be configured to: determine an object ID, determine an object size, generate original object data using the content generator, the object ID, and the object size, store the original object data within an object storage system using the object ID, and store the object ID and object size to metadata storage. The object reader may be configured to read the object ID and object size from metadata storage, retrieve stored object data from the object storage system using the object ID, and regenerate the original object data using the content generator, the object ID, and the object size. The content verifier may be configured to compare the regenerated original object data to the stored object data to identify corruption in the object storage system. The metadata storage may be provided as a locally attached hard disk. In certain embodiments, the object storage system comprises a cluster of storage nodes.

In some embodiments, the system further comprises a storage API module, wherein the object creator stores original object data within the object storage system via the storage API module, and wherein the object reader retrieves stored object data within the object storage system via the storage API module.

In various embodiments, the system further comprises an ID generator configured to generate object IDs.

In certain embodiments, the object reader is configured to retrieve the stored object data as a first data stream and to regenerate the original object data as a second data stream, wherein the content verifier is configured to compare the first and second data streams to identify corruption in the object storage system. The object reader may be configured to retrieve the stored object data and to regenerate the original object data in parallel.

In some embodiments, the content generator is configured to store pre-generated data in a ring buffer and to generate a stream of data using the ring buffer.

In some embodiments, the system described above also includes an object storage system.

### BRIEF DESCRIPTION OF THE DRAWINGS

The concepts, structures, and techniques sought to be protected herein may be more fully understood from the following detailed description of the drawings, in which:

FIG. 1 is a block diagram of an illustrative object storage system;

FIGS. 2-4 are block diagrams of an illustrative system that can be used to test an object storage system;

FIG. 5 is a flow diagram showing an illustrative process that may be used within the systems of FIGS. 1-4; and

FIG. 6 is a schematic representation of an illustrative computer for use with the systems of FIGS. 1-4.

The drawings are not necessarily to scale, or inclusive of all elements of a system, emphasis instead generally being placed upon illustrating the concepts, structures, and techniques sought to be protected herein.

### DETAILED DESCRIPTION

Before describing embodiments of the systems and methods sought to be protected herein, some terms are explained. As used herein, the phrases “computer,” “computing system,” “computing environment,” “processing platform,” “data memory and storage system,” and “data memory and storage system environment” are intended to be broadly construed so as to encompass, for example, private or public cloud computing or storage systems, or parts thereof, as well as other types of systems comprising distributed virtual infrastructure and those not comprising virtual infrastructure. The terms “application,” “program,” “application program,” and “computer application program” herein refer to any type of software application, including desktop applications, server applications, database applications, and mobile applications.

As used herein, the term “storage device” refers to any non-volatile memory (NVM) device, including hard disk drives (HDDs), flash devices (e.g., NAND flash devices), and next generation NVM devices, any of which can be accessed locally and/or remotely (e.g., via a storage attached network (SAN)). The term “storage device” can also refer to a storage array comprising one or more storage devices.

The term “perfect” as used herein in conjunction with verification reliability means verification that is 100% reliable under normal operating conditions. The term “imperfect” as used herein to refer to verification reliability means verification that is less than 100% reliable.

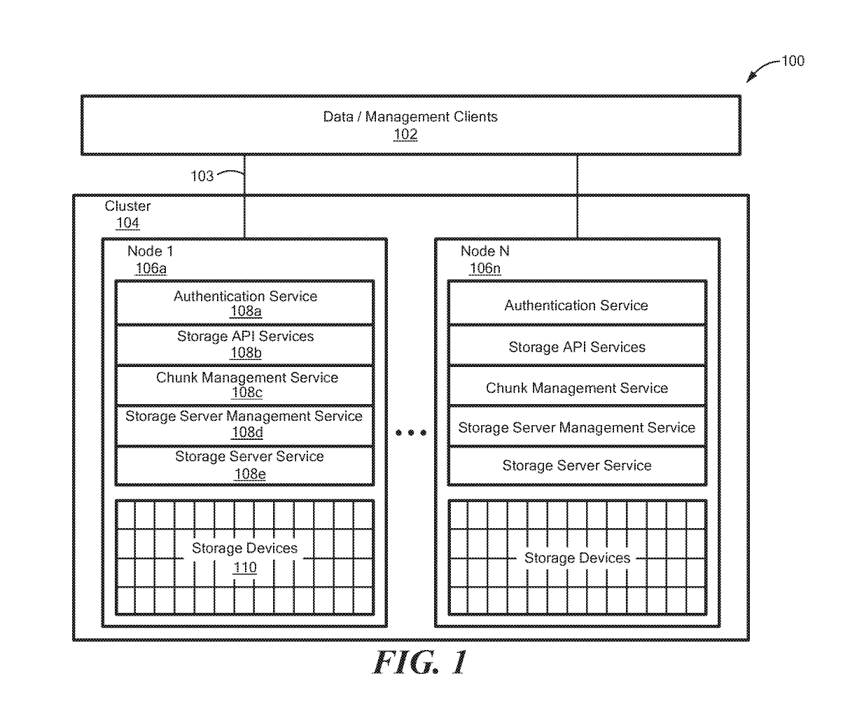

Referring to FIG. 1, an illustrative object storage system 100 includes one or more clients 102 in communication with a storage cluster 104 via a network 103. The network 103 may include any suitable type of communication network or combination thereof, including networks using protocols such as Ethernet, Internet Small Computer System Interface (iSCSI), Fibre Channel (FC), and/or wireless protocols.

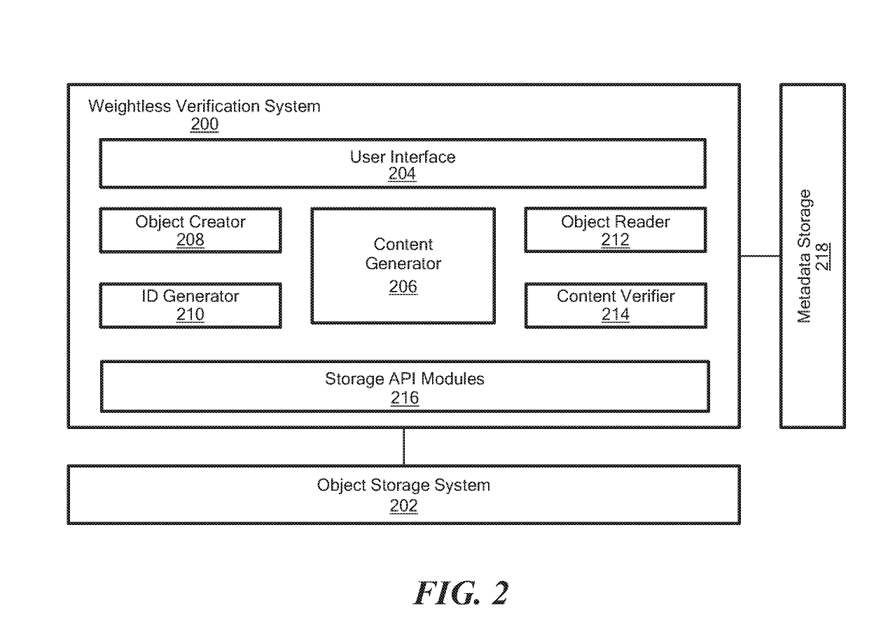

The clients 102 may include user applications, application servers, data management tools, and/or testing systems. In some embodiments, one or more of the clients 102 corresponds to the testing system shown in FIGS. 2-4 and described below in conjunction therewith.

The storage cluster 104 includes one or more storage nodes 106a . . . 106n (generally denoted 106). Storage node 106a, which may be representative of other storage nodes, includes one or more services 108 and one or more storage devices 108. A storage node 106 may include a processor (not shown) configured to execute the services 108.

The illustrative storage node 106a includes the following services: an authentication service 108a to authenticate requests from clients 102; storage API services 108b to parse and interpret requests from clients 102; a chunk management service 108c to facilitate chunk allocation/reclamation for different storage system needs and monitor chunk health and usage; a storage server management service 108d to manage available storage devices capacity and to track storage devices states; and a storage server service 108e to interface with the storage devices 110.

A storage device 100 may comprise one or more physical and/or logical storage devices attached to the storage node 106a. A storage node 106 may utilize VNX,

Symmetrix VMAX, and/or Full Automated Storage Tiering (FAST), which are available from EMC Corporation of Hopkinton, Massachusetts. While vendor-specific terminology may be used to facilitate understanding, it is understood that the concepts, techniques, and structures sought to be protected herein are not limited to use with any specific commercial products.

In general operation, clients 102 issue requests to the storage cluster 104 to read and write data objects (or more simply “objects”). Write requests may include requests to create new objects within the storage cluster 104, as well as requests to update existing objects. Data object read and write requests include an object ID, which uniquely identifies the object within the storage cluster 104. A client request may be received by any available storage node 106. The receiving node 106 may process the request locally and/or may delegate request processing to one or more peer nodes 106. For example, if a client issues an object read request, the receiving node may delegate/proxy the request to peer node where the object's data resides.

In some embodiments, the storage cluster 104 utilizes Elastic Cloud Storage (ECS) from EMC Corporation of Hopkinton, Massachusetts.

FIGS. 2-5 illustrate a technique and related structures for data object verification that can be used, for example, to test object storage system 100 of FIG. 1. The technique, referred to herein as “Weightless Verification,” regenerates the contents of an object for verification using only certain metadata associated with that object. As such, testing systems that utilize Weightless Verification need not store the entire content of an object, or even a checksum thereof, in order to achieve reliable verification. It is enough to store metadata that can be used later to reproduce the original object contents exactly. In various embodiments, the required metadata includes the object's id and size. It will be appreciated that existing testing systems may already store this information locally and, thus, some implementations of WV require no additional storage (hence the term “weightless”).

As shown in TABLE 1, Weightless Verification provides both high reliability and low storage head compared to existing techniques.

TABLE 1

| | Verification Reliability | Storage Overhead |
|---|---|---|
| Object | Perfect | High |
| copy | | |
| Checksum | Imperfect | Medium/Low |
| Weightless | Perfect | Low |
| Verification | | |

Referring to FIG. 2, a testing system 200 implements Weightless Verification to efficiently test object storage systems 202, which may be the same as or similar to object storage system 100 of FIG. 1. The illustrative testing system 200 includes a user interface 204, a content generator 206, an object creator 208, an ID generator 210, an object reader 212, a content verifier 214, and storage API modules 216.

The testing system 200 has read/write access to a storage device 218 for storing object metadata, such as object IDs and sizes. The storage device 218 (referred to herein as “metadata storage”) is distinct from the object storage system 202 and may be provided, for example, as a locally attached disk drive. In some embodiments, metadata storage 218 may be provided as volatile or non-volatile memory.

The user interface 204 may include graphical and/or textual-based interfaces to allow a user to configure tests, to execute tests against the object storage system 202, and to view the results of such tests.

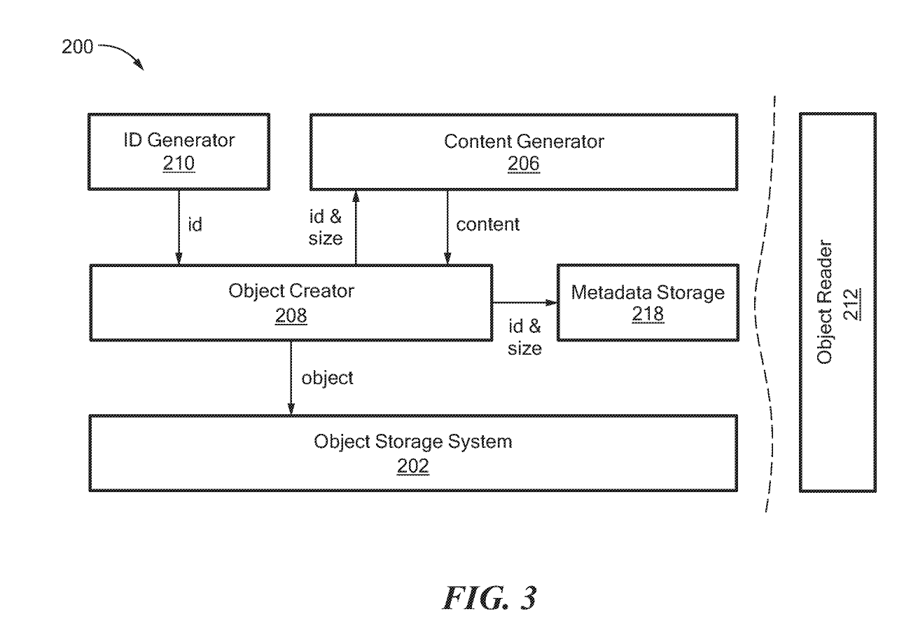

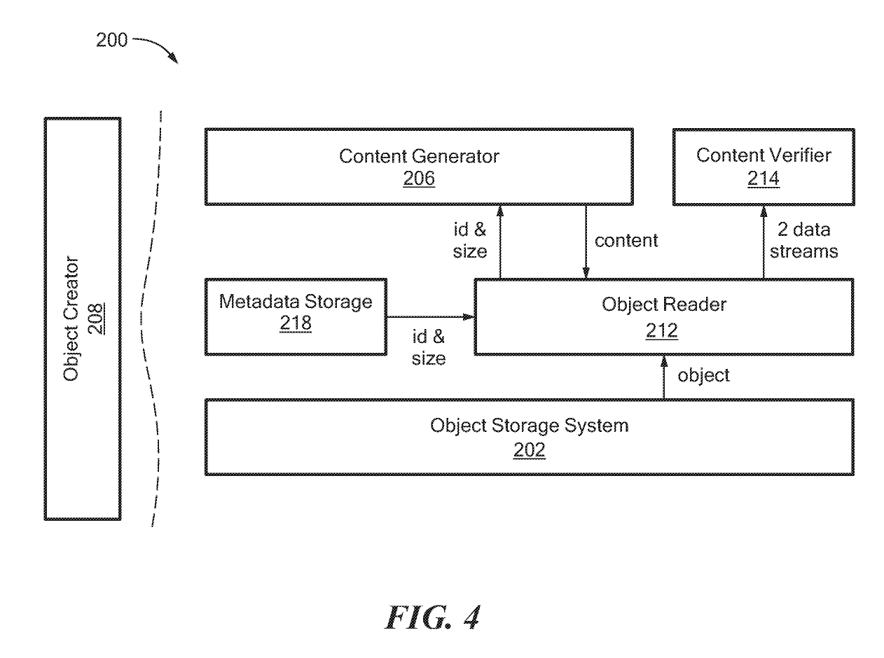

As described below in conjunction with FIGS. 3 and 4, the various system components 204-216 are configured to interact to generate data objects, to store data objects within the object storage system 202, and to subsequently verify the contents of stored data objects. The testing system 200 can efficiently generate and verify a large number of data objects (e.g., thousands or even millions of objects), and thus is well suited for endurance-type tests.

Referring to FIG. 3, in which like elements of FIG. 2 are shown using like reference designations, a testing system 200 can generate and store verifiable objects as follows.

The object creator 208 requests a new object ID from the ID generator. Any suitable technique may be used to generate object IDs, including maintaining a count in memory or generating random (or pseudorandom) values.

Next, the object creator 208 requests object content from the content generator 206. In various embodiments, the request includes a key and an object size. The content generator 206 returns a stream of data that is reproducible based on the key and the object size. In this example, the object ID is used as the key to generate object data, although it should be appreciated that a separate value could be used as the key.

The content generator 206 can use any suitable technique to generate content in a reproducible manner. For testing purposes, it may be desirable to store objects having random or at least quasi-random content. In some embodiments, the content generator 206 generates object data using a pseudo-random number generator (PRNG). Here, the content generator 206 may seed a PRNG using the object ID value, and then invoke the PRNG one or more times to generate a stream of random data having the specific size. In other embodiments, the content generator 206 uses pre-generated data stored in a ring buffer to provide a quasi-random stream of data. Here, the object ID can be used (either directly or indirectly) to index into the ring buffer.

Next, the object creator 208 creates an object within the object storage system 202. This may include sending the object ID and generated object data to the object storage system 202 with an object write request. To provide a layer of abstraction between the object creator 208 and the object storage system 202, the testing system 200 may include one include one or more storage API modules 216 (shown in FIG. 2) via which the object creator 208 indirectly issues requests to the object storage system 202. This allows new types of object storage systems 202 to be tested by simply adding an API module 216.

The object creator 208 writes the object ID and the object size to metadata storage 218. In some embodiments, this is done after the object storage system 200 acknowledges creation of the object. In some embodiments, the object metadata is stored as comma-separated values (CSV).

Referring to FIG. 4, in which like elements of FIGS. 2 and 3 are shown using like reference designations, a testing system 200 can verify stored object content as follows.

For a given object to be verified, the object reader 212 reads an object ID and corresponding object size from metadata storage 218. The object reader 212 requests the content generator 206 to reproduce the original object contents using the object ID and object size. The content generator 206 returns a data stream that exactly matches the original object content stored by the object creator 208 (FIG. 3).

The object reader 212 reads the stored object back from the object storage system 202 by object ID. In some embodiments, the object reader 212 receives data from the content generator 206 and object storage system 202 in parallel.

The object reader 212 passes the two data streams to the content verifier 214, which compares them using any suitable technique (e.g., byte-by-byte comparison). If the data streams are identical, the object passes verification. Otherwise, object corruption is detected and may be reported, for example, by displaying an error message within the user interface 204.

It will be appreciated that Weightless Verification has relatively low I/O and processing overhead compared to existing object content verification techniques. For example, existing systems that use object copies must read the original object from local storage, whereas Weightless Verification regenerates the original object data without slow disk read operations. As another example, existing systems that rely on checksums (e.g., MD5) must perform relatively complex computation a checksum, whereas implementations of Weightless Verification described herein use a ring buffer to retrieve original object data and simple comparison operations to provide fast verification.

The content verification techniques and structures described herein can be used to create testing systems for many different commercially available storage systems, including not only object-based storage systems but also file- and block-based storage systems.

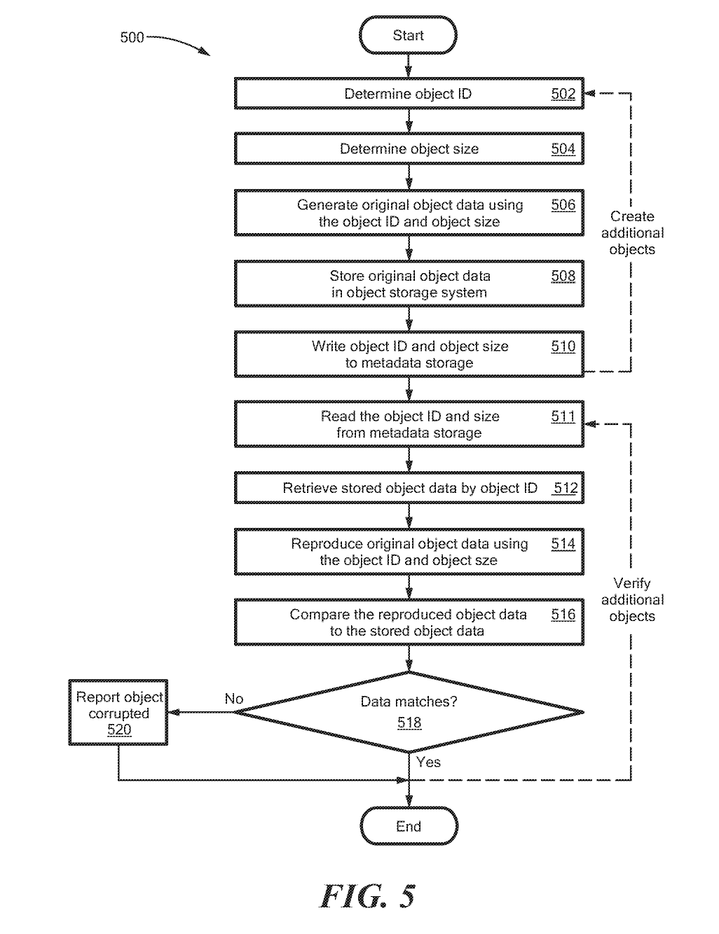

FIG. 5 is a flow diagram showing illustrative processing that can be implemented within a testing system, such as testing system 200 of FIGS. 2-4. Rectangular elements (typified by element 500), herein denoted “processing blocks,” represent computer software instructions or groups of instructions. Diamond shaped elements (typified by element 518), herein denoted “decision blocks,” represent computer software instructions, or groups of instructions, which affect the execution of the computer software instructions represented by the processing blocks.

Alternatively, the processing and decision blocks may represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, structures, and techniques sought to be protected herein. Thus, unless otherwise stated the blocks described below are unordered meaning that, when possible, the functions represented by the blocks can be performed in any convenient or desirable order.

In some embodiments, the processing and decision blocks represent states and transitions, respectively, within a finite-state machine, which can be implemented in software and/or hardware.

Referring to FIG. 5, a method 500 begins at block 502, where an object ID is determined. In some embodiments, the object ID is generated using a suitable technique, such as those described above in conjunction with the ID generator 210 of FIG. 2. At block 504, an object size is determined. In certain embodiments, the object size is specified by a user or automatically selected by a testing system.

At block 506, object data (referred to herein as “original object data”) is generated in a reproducible manner using the object ID and size. At block 508, the original object data is stored in an object storage system. This may include sending a write request to the object storage system with the object ID and the original object data. At block 510, the object ID and size (and possibly other metadata) are stored to metadata storage.

The processing of blocks 502-510 may be repeated to create additional objects for verification. After a suitable number of objects are created, a sufficient number of I/O operations have been performed against the object storage system, and/or a sufficient amount of time has elapsed, verification may proceed according to blocks 512-520. The set of objects to be verified can be determined by reading from metadata storage (block 511).

At block 512, stored object data is retrieved from the object storage system. This may include sending a read request object storage system, the requesting including the object ID.

At block 514, a copy of the original object data is reproduced using the object ID and size. At block 516, the reproduced object data is compared to the stored object data. At block 518, if the two sets of object data match, the object is verified. Otherwise, data corruption may be reported (block 520).

The processing of blocks 511-520 may be repeated to verify additional objects.

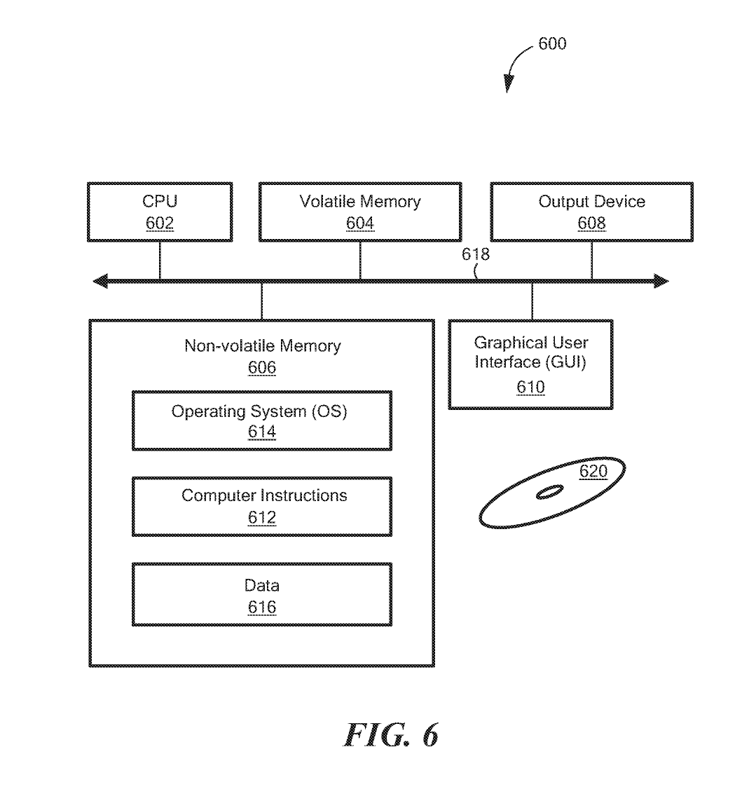

FIG. 6 shows an illustrative computer or other processing device 600 that can perform at least part of the processing described herein. The computer 600 includes a processor 602, a volatile memory 604, a non-volatile memory 606 (e.g., hard disk), an output device 608 and a graphical user interface (GUI) 610 (e.g., a mouse, a keyboard, a display, for example), each of which is coupled together by a bus 618. The non-volatile memory 606 stores computer instructions 612, an operating system 614, and data 616. In one example, the computer instructions 612 are executed by the processor 602 out of volatile memory 604. In one embodiment, an article 620 comprises non-transitory computer-readable instructions.

Processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

All references cited herein are hereby incorporated herein by reference in their entirety.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that scope of protection sought herein should not be limited to the described embodiments but rather should be limited only by the spirit and scope of the following claims.

What is claimed is:

1. A method comprising:
determining an object ID;
determining an object size;
generating original object data using the object ID and the object size;
storing the original object data within an object storage system using the object ID;
writing the object ID and object size to the metadata storage;
reading the object ID and object size from the metadata storage;
retrieving the stored object data from the object storage system using the object ID;
regenerating the original object data using the object ID and the object size; and
comparing the regenerated original object data to the stored object data to identify corruption in the object storage system.

2. The method of claim 1 wherein determining the object ID comprises generating an object ID.

3. The method of claim 1 further comprising:
receiving the stored object data as a first data stream;
receiving the regenerated original object data as a second data stream; and
comparing the first and second data streams to identify corruption in the object storage system.

4. The method of claim 3 further comprising receiving the first and second data streams in parallel.

5. The method of claim 1 further comprising storing pre-generated data in a ring buffer, wherein generating original object data comprising reading data from the ring buffer.

6. The method of claim 1 wherein the object storage system comprises a cluster of storage nodes.

7. A system comprising:
a content generator configured to generate a stream of data having a specified size, the stream of data reproducible based upon a specified key;
an object creator configured to:
determine an object ID,
determine an object size,
generate original object data using the content generator, the object ID, and the object size,
store the original object data within an object storage system using the object ID, and
store the object ID and object size to metadata storage;
an object reader configured to:
read the object ID and object size from metadata storage,
retrieve stored object data from the object storage system using the object ID, and
regenerate the original object data using the content generator, the object ID, and the object size; and
a content verifier configure to:
compare the regenerated original object data to the stored object data to identify corruption in the object storage system.

8. The system of claim 7 further comprising a storage API module, wherein the object creator stores original object data within the object storage system via the storage API module, and wherein the object reader retrieves stored object data within the object storage system via the storage API module.

9. The system of claim 7 wherein the metadata storage is provided as a locally attached hard disk.

10. The system of claim 7 further comprising an ID generator configured to generate object IDs.

11. The system of claim 7 wherein the object reader is configured to retrieve the stored object data as a first data stream and to regenerate the original object data as a second data stream, wherein the content verifier is configured to compare the first and second data streams to identify corruption in the object storage system.

12. The system of claim 11 wherein the object reader is configured to retrieve the stored object data and to regenerate the original object data in parallel.

13. The system of claim 7 wherein the content generator is configured to store pre-generated data in a ring buffer and to generate a stream of data using the ring buffer.

14. The system of claim 7 wherein the object storage system comprises a cluster of storage nodes.

15. A system comprising:
an object storage system; and
a testing system comprising:
an object creator configured to:
determine an object ID,
determine an object size,
generate original object data using the object ID and the object size,
store the original object data within the object storage system using the object ID, and
store the object ID and object size to metadata storage;
an object reader configured to:
read the object ID and object size from metadata storage,
retrieve stored object data from the object storage system using the object ID, and
regenerate the original object data using the object ID and the object size; and
a content verifier configure to:
compare the regenerated original object data to the stored object data to identify corruption in the object storage system.

16. The system of claim 15 wherein the object storage system comprises a cluster of storage nodes.
